(19) United States
(12) Patent Application Publication
(10) Pub. No.: US 2026/0183881 A1
(43) Pub. Date: Jul. 2, 2026

(54) FLEXIBLE MANUFACTURING SYSTEM AND FLEXIBLE MANUFACTURING METHOD THEREOF

(71) Applicant: Delta Electronics, Inc., Taoyuan City (CN)

(72) Inventor: Yao-Nan SU, Taoyuan City (TW)

(21) Appl. No.: 19/210,610

(22) Filed: May 16, 2025

(30) Foreign Application Priority Data
Dec. 26, 2024 (CN) 202411933713.3

(51) Int. Cl. B23Q 7/14

(52) U.S. Cl. CPC B23Q 7/1452

(57) ABSTRACT

A flexible manufacturing system is provided. The flexible manufacturing system includes a starting feeding platform, a first production line, a second production line, a terminal discharging platform, and a transfer apparatus. The first production line includes a plurality of first working machines and a first conveying mechanism. The second production line includes a plurality of second working machines and a second conveying mechanism. The terminal discharging platform is disposed at the downstream of the second production line. The transfer apparatus is disposed between the first production line and the second production line.

### CROSS REFERENCE TO RELATED APPLICATIONS

This Application claims priority of China Patent Application No. 2024119337133, filed on Dec. 26, 2024, the entirety of which is incorporated by reference herein.

### BACKGROUND OF THE INVENTION

### Field of the Invention

The present invention relates to a flexible manufacturing system, and in particular it relates to a flexible manufacturing system with a transfer apparatus.

### Description of the Related Art

Conventional manufacturing systems primarily adopt assembly lines for mass production. However, such conventional systems have the following drawbacks: (1) Existing production lines can only follow the sequential order of machine connections, and lack the flexibility to adjust production steps. (2) In the event of anomalies during the workpiece production process, manual intervention is required to resolve the issue; otherwise, subsequent production will be blocked. (3) Processing can only occur sequentially, without the ability for skip-station production.

These limitations result in a lack of flexibility and difficulty in mixed-line production. Therefore, there is a need to improve current manufacturing systems.

### BRIEF SUMMARY OF THE INVENTION

In one embodiment, a flexible manufacturing system is provided. The flexible manufacturing system includes a starting feeding platform, a first production line, a second production line, a terminal discharging platform, and a transfer apparatus. The first production line includes a plurality of first working machines and a first conveying mechanism, wherein the starting feeding platform is disposed at the upstream of the first production line to deliver a workpiece to the first production line, the first conveying mechanism conveys the workpiece, and at least one of the first working machines processes the workpiece. The second production line includes a plurality of second working machines and a second conveying mechanism, wherein the workpiece is adapted to enter the second production line after leaving the first production line, the second conveying mechanism conveys the workpiece, and at least one of the second working machines processes the workpiece. The terminal discharging platform is disposed at the downstream of the second production line, wherein the workpiece is moved from the second production line to the terminal discharging platform for discharging. The transfer apparatus is disposed between the first production line and the second production line, wherein the transfer apparatus is adapted to pick up the workpiece from the first production line or the second production line and transfer the workpiece.

In one embodiment, each first working machine includes a first working zone, each second working machine includes a second working zone, and the first conveying mechanism and the second conveying mechanism are positioned facing the transfer apparatus.

In one embodiment, the flexible manufacturing system further includes a lifting mechanism, wherein the lifting mechanism is disposed on the first conveying mechanism or the second conveying mechanism and is adapted to lift or lower the workpiece.

In one embodiment, the flexible manufacturing system further includes a collection unit, wherein in response to the workpiece being determined to be a defective workpiece, the lifting mechanism moves the defective workpiece, and the defective workpiece is transferred to the collection unit for storage.

In one embodiment, the first conveying mechanism and the second conveying mechanism comprise a plurality of conveying rollers, the lifting mechanism is disposed beneath the first conveying mechanism or the second conveying mechanism, and in response to the workpiece being determined to be a defective workpiece, the lifting mechanism passes through the conveying rollers and lifts the defective workpiece.

In one embodiment, the lifting mechanism comprises a pneumatic cylinder, a first pushing arm, and a second pushing arm, the workpiece is placed in a carrier plate, the pneumatic cylinder is adapted to drive the first pushing arm and the second pushing arm, and the first pushing arm and the second pushing arm are adapted to pass through the conveying rollers and lift the carrier plate.

In one embodiment, the flexible manufacturing system further includes an automatic warehouse, wherein the first production line, the second production line, and the transfer apparatus are all disposed within the automatic warehouse.

In one embodiment, the first working machines are arranged along a first straight line, the second working machines are arranged along a second straight line, and the first straight line is parallel to the second straight line.

In one embodiment, the first conveying mechanism is not connected to the second conveying mechanism, and the transfer apparatus moves the workpiece from the first production line to the second production line.

In one embodiment, the flexible manufacturing system further includes an intermediate discharging platform. The intermediate discharging platform is disposed at the downstream of the first production line, wherein the workpiece is moved from the first production line to the intermediate discharging platform for buffering or discharging.

In one embodiment, the flexible manufacturing system further includes an intermediate feeding platform. The intermediate feeding platform is disposed at the upstream of the second production line, to feed the workpiece into the second production line, wherein the transfer apparatus is adapted to move the workpiece from the intermediate discharging platform to the intermediate feeding platform.

In one embodiment, the flexible manufacturing system further includes an intermediate feeding platform. The intermediate feeding platform is disposed at the upstream of the second production line, to feed the workpiece into the second production line.

In one embodiment, the first conveying mechanism and the second conveying mechanism comprise a plurality of conveying devices, and the conveying devices correspond to the first working machines and the second working machines.

In one embodiment, the flexible manufacturing system further includes a plurality of lifting mechanisms, wherein the lifting mechanisms correspond to the conveying device.

In one embodiment, a flexible manufacturing method is provided. First, the flexible manufacturing system mentioned above is provided. Then, a control unit is provided, wherein the control unit is coupled to the first production line, the second production line and the transfer apparatus, and the control unit controls the transfer apparatus to load and unload the workpiece from the first production line and the second production line based on information from the first and second production lines.

In one embodiment, the flexible manufacturing method further includes the following steps. When the first production line or the second production line determines that the workpiece is a defective workpiece, the control unit causes the defective workpiece to be removed from the first or second production line based on a defect signal from the first or second production line, wherein the defective workpiece has not passed through all of the first working machines or all of the second working machines. Then, a collection unit is provided. Next, the transfer apparatus moves the defective workpiece to the collection unit.

In one embodiment, the flexible manufacturing method further includes the following steps. First, a lifting mechanism is provided, which is disposed on the first conveying mechanism or the second conveying mechanism. Then, the control unit, based on the defect signal from the first or second production line, causes the lifting mechanism to lift the defective workpiece upward. Next, the control unit also controls the transfer apparatus to move the defective workpiece from the lifting mechanism to the collection unit.

In one embodiment, the flexible manufacturing method further includes the following step. First, the control unit, based on a skip-station setting, causes the transfer apparatus to pick up the workpiece from the first or second production line, wherein the workpiece has not passed through all of the first working machines or all of the second working machines.

In one embodiment, the flexible manufacturing method further includes the following steps. First, an intermediate discharging platform is disposed at the downstream of the first production line, wherein the workpiece is moved from the first production line to the intermediate discharging platform for buffering or discharging. Next, an intermediate feeding platform is disposed at the upstream of the second production line, to feed the workpiece into the second production line, wherein the transfer apparatus is adapted to move the workpiece from the intermediate discharging platform to the intermediate feeding platform.

Utilizing the flexible manufacturing system of the embodiments of the invention, the control unit can, based on the skip-station setting, use the transfer apparatus to pick up the workpiece from the first production line and move it to the second production line for skip-station processing, thereby enabling flexible adjustment of production steps. When the first production line or the second production line determines that the workpiece is a defective workpiece, the control unit, based on the defect signal provided by the first production line or the second production line, removes the defective workpiece from the first or second production line to prevent subsequent production blockages. Compared to conventional technologies, the flexible manufacturing system of the present embodiment offers higher production efficiency and meets more diverse production requirements.

### BRIEF DESCRIPTION OF THE DRAWINGS

The present invention can be more fully understood by reading the subsequent detailed description and examples with references made to the accompanying drawings, wherein:

FIG. 1 shows a flexible manufacturing system of an embodiment of the invention;

FIG. 2A shows a lifting mechanism of an embodiment of the invention;

FIG. 2B shows a lifting mechanism of another embodiment of the invention;

FIG. 3 shows a control unit of the embodiment of the invention;

FIG. 4 shows the flexible manufacturing method of a first embodiment of the invention;

FIG. 5 shows the flexible manufacturing method of a second embodiment of the invention;

FIG. 6 shows the flexible manufacturing method of a third embodiment of the invention; and

FIG. 7 shows the flexible manufacturing method of a fourth embodiment of the invention.

### DETAILED DESCRIPTION OF THE INVENTION

The following description is made for the purpose of illustrating the general principles of the invention and should not be taken in a limiting sense. The scope of the invention is best determined by reference to the appended claims.

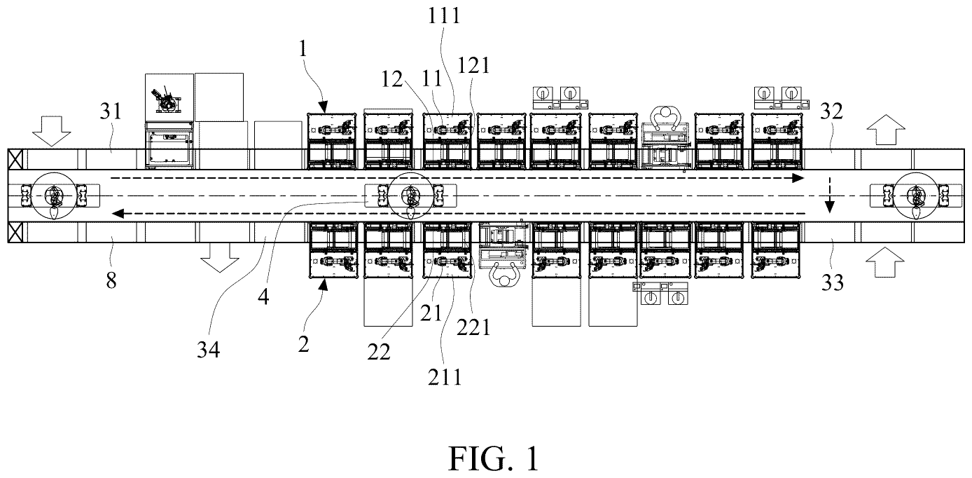

FIG. 1 shows a flexible manufacturing system of an embodiment of the invention. With reference to FIG. 1, the flexible manufacturing system of the embodiment of the invention includes a starting feeding platform 31, a first production line 1, a second production line 2, a terminal discharging platform 34 and a transfer apparatus 4. The first production line 1 includes a plurality of first working machines 11 and a first conveying mechanism 12. The starting feeding platform 31 is disposed at the upstream of the first production line 1 to deliver a workpiece (not shown) to the first production line 1. The first conveying mechanism 12 conveys the workpiece. At least one of the first working machines 11 processes the workpiece. The second production line 2 includes a plurality of second working machines 21 and a second conveying mechanism 22. The workpiece is adapted to enter the second production line 2 after leaving the first production line 1. The second conveying mechanism 22 conveys the workpiece, and at least one of the second working machines 21 processes the workpiece. The terminal discharging platform 34 is disposed at the downstream of the second production line 2. The workpiece is moved from the second production line 2 to the terminal discharging platform 34 for discharging. The transfer apparatus 4 is disposed between the first production line 1 and the second production line 2, wherein the transfer apparatus 4 is adapted to pick up the workpiece from the first production line 1 or the second production line 2 and transfer the workpiece.

With reference to FIG. 1, in one embodiment, each first working machine 11 includes a first working zone 111. Each second working machine 21 includes a second working zone 211. The first conveying mechanism 12 is located between the first working zones 111 and the second conveying mechanism 22. The second conveying mechanism 22 is located between the second working zones 211 and the first conveying mechanism 12. In other words, the first conveying mechanism 12 and the second conveying mechanism 22 are located on an inner side of the flexible manufacturing system. The first working zones 111 and the second working zones 211 are located on an outer side of the flexible manufacturing system. The first conveying mechanism 12 and the second conveying mechanism 22 are positioned facing the transfer apparatus 4.

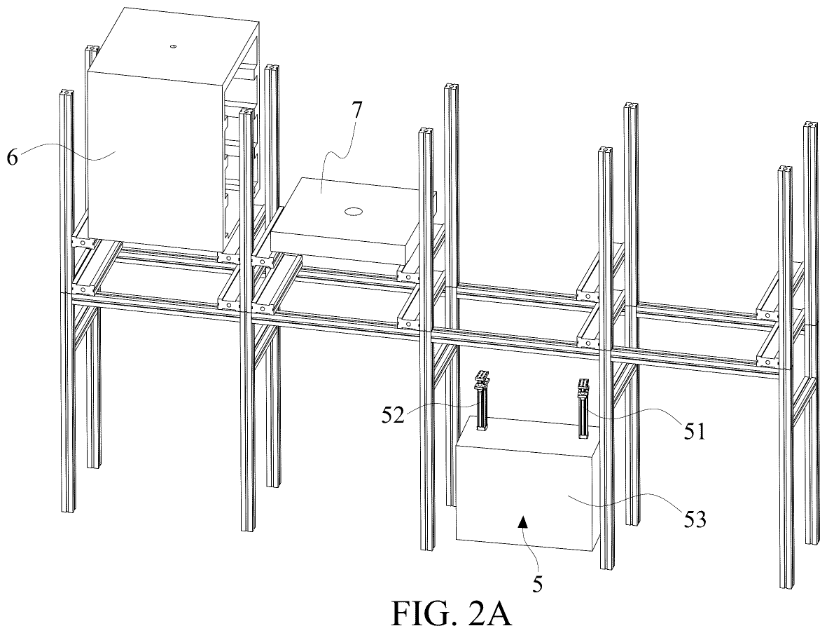

FIG. 2A shows a lifting mechanism of an embodiment of the invention. With reference to FIGS. 1 and 2A, in one embodiment, the flexible manufacturing system further includes a lifting mechanism 5. The lifting mechanism 5 is disposed on the first conveying mechanism 12 or the second conveying mechanism 22 and is adapted to lift or lower the workpiece.

With reference to FIGS. 1 and 2A, in one embodiment, the flexible manufacturing system further includes a collection unit 6. In response to the workpiece being determined to be a defective workpiece, the lifting mechanism 5 moves the defective workpiece, and the defective workpiece is transferred to the collection unit 6 for storage. With reference to FIG. 1, in one embodiment, the defective workpiece is finally moved to a defective workpiece container 8.

With reference to FIGS. 1 and 2A, in one embodiment, the first conveying mechanism 12 and the second conveying mechanism 22 comprise a plurality of conveying rollers (the first conveying rollers 121 and the second conveying rollers 221 as shown in FIG. 1). The lifting mechanism 5 is disposed beneath one or more first conveying mechanisms 12 or one or more second conveying mechanisms 22. In response to the workpiece being determined to be a defective workpiece, the lifting mechanism 5 passes through the conveying rollers and lifts the defective workpiece.

With reference to FIGS. 1 and 2A, in one embodiment, the lifting mechanism 5 comprises a pneumatic cylinder 53, a first pushing arm 51, and a second pushing arm 52. The workpiece is placed in a carrier plate 7. The pneumatic cylinder 53 is adapted to drive the first pushing arm 51 and the second pushing arm 52. The first pushing arm 51 and the second pushing arm 52 are adapted to pass through the conveying rollers and lift the carrier plate 7. The disclosure is not meant to restrict the invention. In another embodiment, the lifting mechanism may include other pushing means such as a threaded rod or a cam.

FIG. 2B shows a lifting mechanism of another embodiment of the invention. With reference to FIGS. 1 and 2B, in one embodiment, the first conveying mechanism comprises a plurality of conveying devices (such as the conveying rollers mentioned above). The conveying devices correspond to the first working machines. The flexible manufacturing system further includes a plurality of lifting mechanisms 5. The lifting mechanisms 5 correspond to the conveying devices.

With reference to FIG. 1, in one embodiment, the flexible manufacturing system further includes an automatic warehouse (not shown). The first production line 1, the second production line 2, and the transfer apparatus 4 are all disposed within the automatic warehouse (not shown).

With reference to FIG. 1, in one embodiment, the first working machines 11 are arranged along a first straight line, the second working machines 21 are arranged along a second straight line, and the first straight line is parallel to the second straight line.

With reference to FIG. 1, in one embodiment, the first conveying mechanism 12 is not connected to the second conveying mechanism 22. The transfer apparatus 4 moves the workpiece from the first production line 1 to the second production line 2. In one embodiment, the workpiece is moved along the path labeled by the dotted arrow of FIG. 1. The disclosure is not meant to restrict the invention. In another embodiment, the conveying mechanism 12 can be connected to the second conveying mechanism 22.

With reference to FIG. 1, in one embodiment, the flexible manufacturing system further includes an intermediate discharging platform 32 and an intermediate feeding platform 33. The intermediate discharging platform 32 is disposed at the downstream of the first production line 1. The workpiece is moved from the first production line 1 to the intermediate discharging platform 32 for buffering or discharging. The intermediate feeding platform 33 is disposed at the upstream of the second production line 2, to feed the workpiece into the second production line 2. The transfer apparatus 4 is adapted to move the workpiece from the intermediate discharging platform 32 to the intermediate feeding platform 33. In one embodiment, based on the manufacturing process requirements, the first production line 1 and the second production line 2 can work independently. The disclosure is not meant to restrict the invention.

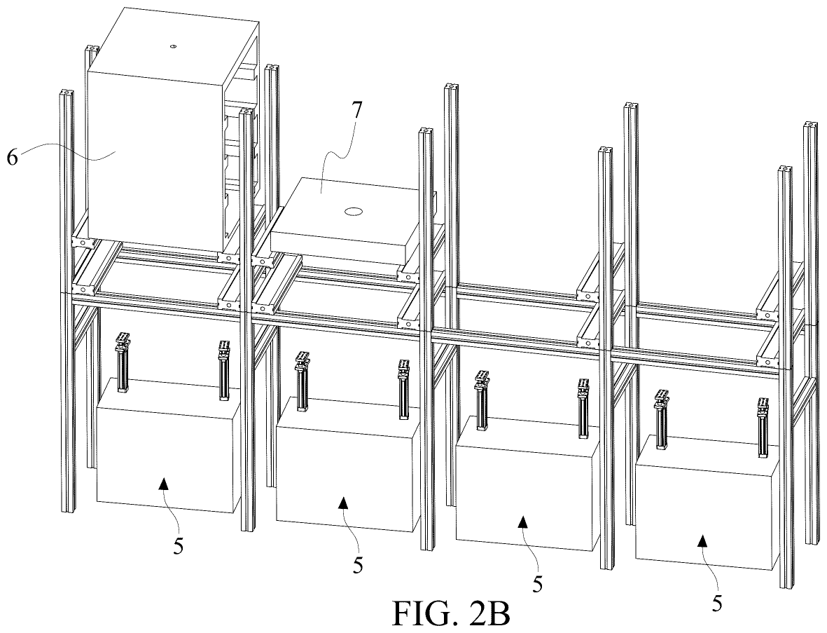

FIG. 3 shows a control unit of the embodiment of the invention. With reference to FIG. 3, in one embodiment, the flexible manufacturing system mentioned further comprises a control unit C. The control unit C is coupled to the first production line 1, the second production line 2 and the transfer apparatus 4. The control unit C controls the transfer apparatus 4 to load and unload the workpiece from the first production line 1 and the second production line 2 based on information from the first production line 1 and the second production line 2.

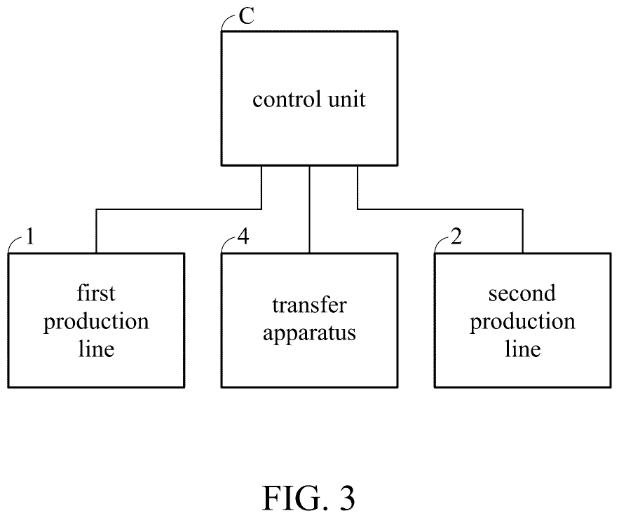

In one embodiment, a flexible manufacturing method is provided and manufacts products by the control unit, the first production line, the second production line and the transfer apparatus mentioned above. FIG. 4 shows the flexible manufacturing method of a first embodiment of the invention. With reference to FIG. 4, when the first production line or the second production line determines that the workpiece is a defective workpiece, the control unit causes the defective workpiece to be removed from the first or second production line based on a defect signal from the first or second production line, wherein the defective workpiece has not passed through all of the first working machines or all of the second working machines (S11). Then, a collection unit is provided (S12). Next, the transfer apparatus moves the defective workpiece to the collection unit (S13).

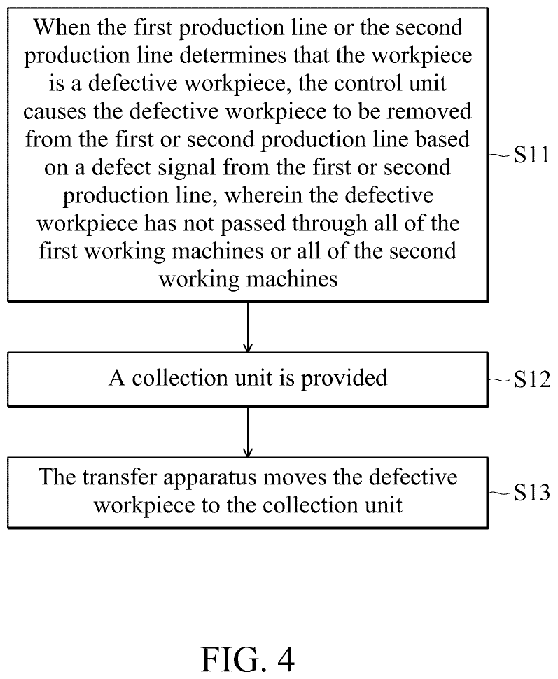

FIG. 5 shows the flexible manufacturing method of a second embodiment of the invention. With reference to FIG. 5, in one embodiment, the flexible manufacturing method further includes the following steps. First, a lifting mechanism is provided, which is disposed on the first conveying mechanism or the second conveying mechanism (S21). Then, the control unit, based on the defect signal from the first or second production line, causes the lifting mechanism to lift the defective workpiece upward (S22). Next, the control unit also controls the transfer apparatus to move the defective workpiece from the lifting mechanism to the collection unit (S23).

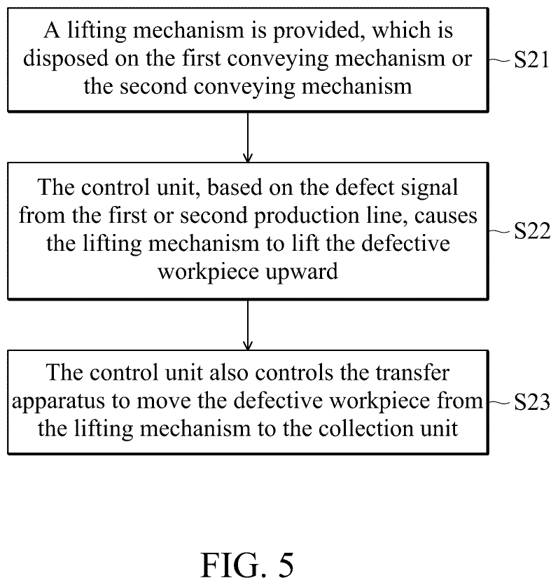

FIG. 6 shows the flexible manufacturing method of a third embodiment of the invention. With reference to FIG. 6, in one embodiment, the flexible manufacturing method further includes the following step. First, the control unit, based on a skip-station setting, causes the transfer apparatus to pick up the workpiece from the first or second production line, wherein the workpiece has not passed through all of the first working machines or all of the second working machines (S31).

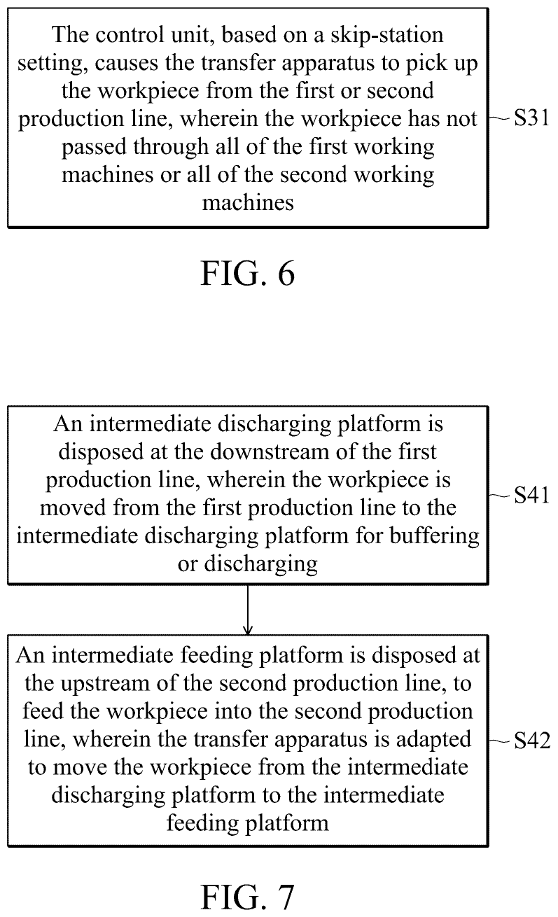

FIG. 7 shows the flexible manufacturing method of a fourth embodiment of the invention. With reference to FIG. 7, in one embodiment, the flexible manufacturing method further includes the following steps. First, an intermediate discharging platform is disposed at the downstream of the first production line, wherein the workpiece is moved from the first production line to the intermediate discharging platform for buffering or discharging (S41). Next, an intermediate feeding platform is disposed at the upstream of the second production line, to feed the workpiece into the second production line, wherein the transfer apparatus is adapted to move the workpiece from the intermediate discharging platform to the intermediate feeding platform (S42).

Utilizing the flexible manufacturing system of the embodiments of the invention, the control unit can, based on the skip-station setting, use the transfer apparatus to pick up the workpiece from the first production line and move it to the second production line for skip-station processing, thereby enabling flexible adjustment of production steps. When the first production line or the second production line determines that the workpiece is a defective workpiece, the control unit, based on the defect signal provided by the first production line or the second production line, removes the defective workpiece from the first or second production line to prevent subsequent production blockages. Compared to conventional technologies, the flexible manufacturing system of the present embodiment offers higher production efficiency and meets more diverse production requirements.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

1. A flexible manufacturing system, comprising:
a starting feeding platform;
a first production line, comprising a plurality of first working machines and a first conveying mechanism, wherein the starting feeding platform is disposed at the upstream of the first production line to deliver a workpiece to the first production line, the first conveying mechanism conveys the workpiece, and at least one of the first working machines processes the workpiece;
a second production line, comprising a plurality of second working machines and a second conveying mechanism, wherein the workpiece is adapted to enter the second production line after leaving the first production line, the second conveying mechanism conveys the workpiece, and at least one of the second working machines processes the workpiece;
a terminal discharging platform, disposed at the downstream of the second production line, wherein the workpiece is moved from the second production line to the terminal discharging platform for discharging; and
a transfer apparatus, disposed between the first production line and the second production line, wherein the transfer apparatus is adapted to pick up the workpiece from the first production line or the second production line and transfer the workpiece.

2. The flexible manufacturing system as claimed in claim 1, wherein each first working machine includes a first working zone, each second working machine includes a second working zone, and the first conveying mechanism and the second conveying mechanism are positioned facing the transfer apparatus.

3. The flexible manufacturing system as claimed in claim 2, further comprising a lifting mechanism, wherein the lifting mechanism is disposed on the first conveying mechanism or the second conveying mechanism and is adapted to lift or lower the workpiece.

4. The flexible manufacturing system as claimed in claim 3, further comprising a collection unit, wherein in response to the workpiece being determined to be a defective workpiece, the lifting mechanism moves the defective workpiece, and the defective workpiece is transferred to the collection unit for storage.

5. The flexible manufacturing system as claimed in claim 4, wherein the first conveying mechanism and the second conveying mechanism comprise a plurality of conveying rollers, the lifting mechanism is disposed beneath the first conveying mechanism or the second conveying mechanism, and in response to the workpiece being determined to be a defective workpiece, the lifting mechanism passes through the conveying rollers and lifts the defective workpiece.

6. The flexible manufacturing system as claimed in claim 5, wherein the lifting mechanism comprises a pneumatic cylinder, a first pushing arm, and a second pushing arm, the workpiece is placed in a carrier plate, the pneumatic cylinder is adapted to drive the first pushing arm and the second pushing arm, and the first pushing arm and the second pushing arm are adapted to pass through the conveying rollers and lift the carrier plate.

7. The flexible manufacturing system as claimed in claim 3, further comprising an automatic warehouse, wherein the first production line, the second production line, and the transfer apparatus are all disposed within the automatic warehouse.

8. The flexible manufacturing system as claimed in claim 3, wherein the first working machines are arranged along a first straight line, the second working machines are arranged along a second straight line, and the first straight line is parallel to the second straight line.

9. The flexible manufacturing system as claimed in claim 3, wherein the first conveying mechanism is not connected to the second conveying mechanism, and the transfer apparatus moves the workpiece from the first production line to the second production line.

10. The flexible manufacturing system as claimed in claim 9, further comprising:
an intermediate discharging platform, disposed at the downstream of the first production line, wherein the workpiece is moved from the first production line to the intermediate discharging platform for buffering or discharging.

11. The flexible manufacturing system as claimed in claim 10, further comprising:
an intermediate feeding platform, disposed at the upstream of the second production line, to feed the workpiece into the second production line, wherein the transfer apparatus is adapted to move the workpiece from the intermediate discharging platform to the intermediate feeding platform.

12. The flexible manufacturing system as claimed in claim 9, further comprising:
an intermediate feeding platform, disposed at the upstream of the second production line, to feed the workpiece into the second production line.

13. The flexible manufacturing system as claimed in claim 1, wherein the first conveying mechanism and the second conveying mechanism comprise a plurality of conveying devices, and the conveying devices correspond to the first working machines and the second working machines.

14. The flexible manufacturing system as claimed in claim 13, further comprising a plurality of lifting mechanisms, wherein the lifting mechanisms correspond to the conveying device.

15. A flexible manufacturing method, comprising:
providing the flexible manufacturing system as claimed in claim 1;
providing a control unit, wherein the control unit is coupled to the first production line, the second production line and the transfer apparatus, and the control unit controls the transfer apparatus to load and unload the workpiece from the first production line and the second production line based on information from the first and second production lines.

16. The flexible manufacturing method as claimed in claim 15, further comprising:
in response to the first production line or the second production line determining that the workpiece is a defective workpiece, the control unit causes the defective workpiece to be removed from the first or second production line based on a defect signal from the first or second production line, wherein the defective workpiece has not passed through all of the first working machines or all of the second working machines;
providing a collection unit; and
the transfer apparatus moves the defective workpiece to the collection unit.

17. The flexible manufacturing method as claimed in claim 16, further comprising:
providing a lifting mechanism, disposed on the first conveying mechanism or the second conveying mechanism;
the control unit, based on the defect signal from the first or second production line, causing the lifting mechanism to lift the defective workpiece upward; and
the control unit also controlling the transfer apparatus to move the defective workpiece from the lifting mechanism to the collection unit.

18. The flexible manufacturing method as claimed in claim 17, further comprising:
the control unit, based on a skip-station setting, causing the transfer apparatus to pick up the workpiece from the first or second production line, wherein the workpiece has not passed through all of the first working machines or all of the second working machines.

19. The flexible manufacturing method as claimed in claim 15, further comprising:
providing an intermediate discharging platform, disposed at the downstream of the first production line, wherein the workpiece is moved from the first production line to the intermediate discharging platform for buffering or discharging; and
providing an intermediate feeding platform, disposed at the upstream of the second production line, to feed the workpiece into the second production line, wherein the transfer apparatus is adapted to move the workpiece from the intermediate discharging platform to the intermediate feeding platform.
